(19) United States
(12) Patent Application Publication
(10) Pub. No.: US 2021/0158085 A1
(43) Pub. Date: May 27, 2021

(54) SYSTEMS AND METHODS FOR AUTOMATIC MODEL GENERATION

(71) Applicant: ZestFinance, Inc., Burbank, CA (US)

(72) Inventor: Jerome Louis Budzik, Burbank, CA (US)

(21) Appl. No.: 17/104,616

(22) Filed: Nov. 25, 2020

Related U.S. Application Data
(60) Provisional application No. 62/940,113, filed on Nov. 25, 2019.

(51) Int. Cl. G06K 9/62; G06N 3/08; G06N 20/00

(52) U.S. Cl. CPC G06K 9/6227; G06K 9/6228; G06K 9/6262; G06N 20/00; G06K 9/6232; G06N 3/08; G06K 9/6202

(57) ABSTRACT

Systems and methods for automatically generating models using machine learning techniques.

### CROSS-REFERENCE TO RELATED APPLICATIONS

This application claims the benefit of U.S. Provisional Application No. 62/940,113, filed 25 Nov. 2019, which is incorporated herein in its entirety by this reference.

### TECHNICAL FIELD

This invention relates to the data modeling field, and more specifically to a new and useful modelling system.

### BACKGROUND

Data science tasks are typically performed by data scientists that have specialized knowledge related to generating, validating, and deploying machine learning models.

There is a need in the data modeling field to create new and useful systems and methods for data modeling. The embodiments of the present application provide such new and useful systems and methods.

### BRIEF DESCRIPTION OF THE FIGURES

FIGS. 1A-B illustrate schematics of a system, in accordance with embodiments.

FIGS. 2A-D illustrates a method, in accordance with embodiments.

FIG. 3 illustrates schematics of a system, in accordance with embodiments.

FIG. 4 illustrates a method, in accordance with embodiments.

FIG. 5 illustrates an exemplary user interface for receiving selection of a model purpose, in accordance with embodiments.

FIG. 6 illustrates an exemplary user interface for selection of a generated model, in accordance with embodiments.

### DESCRIPTION OF THE PREFERRED EMBODIMENTS

The following description of preferred embodiments of the present application are not intended to be limiting, but to enable any person skilled in the art of to make and use these embodiments described herein.

### 1. Overview

Data science tasks are typically performed by data scientists that have specialized knowledge related to data modeling. Such tasks often include processing raw data, feature selection, model generation, model validation, and model execution.

Embodiments herein enable simplified data modeling by automatically generating a machine learning model based on supplied data.

In some variations, a model purpose for the model is identified, and the model is generated based on the identified purpose. In some variations, the model purpose is selected from a list of pre-determined model purposes by indication of the user interacting with a graphical user interface. For example, a user interface can display a list of selectable model purposes, and the system can receive user selection of one of the selectable model purposes via the user interface. In some implementations, the identified purpose is used to identify functional constraints of the model that is to be generated. For example, a “credit risk evaluation” purpose might identify a first set of constraints (e.g., features that are useful in predicting credit risk). In some implementations, the identified purpose identifies a specific domain (e.g, “generic lending product”, “auto loan”, “mortgage loan”, “credit card”, “installment loan”, etc.). In some implementations, the system includes model purpose data that identifies at least one of the following for each model purpose supported by the system: data sources, data sets, features, canonical features, a prediction target, model type, model parameters, hyperparameters. In some implementations, the system includes model purpose data for an identified purpose, and the model purpose data is used to generate the model. For example, the model purpose data can be used to select features or select model parameters (type of model, target, hyperparameters, etc.). In some implementations, model purpose data includes at least one model template.

In some variations, the model purpose data is generated by domain experts (e.g., data scientists, business analysts, and the like) having specific domain knowledge related to the identified purpose. In some implementations, the model purpose data is received via a computing system (e.g., 131) (e.g., of a domain expert). For example, data scientists with experience with auto-loan originations can generate the model purpose data for an “auto loan origination” purpose, and this auto-loan origination model purpose data can be used to automatically generate models for “auto loan origination” purposes without further input from a data scientist.

In some variations, the model purpose relates to consumer loan origination, and results of the model are used to determine whether to grant a consumer loan. In some variations, the model purpose relates to business loan origination, and results of the model are used to determine whether to grant a loan to a business. In other variations, the model purpose relates to loan repayment prediction, and results of the model are used to determine whether a loan already granted will be repaid. In other variations, the model purpose relates to identifying consumers to solicit for a new loan, and the results of the model are used to determine which consumers to solicit to apply for a loan. In other variations, the model purpose relates to identifying curable loans, and the results of the model are used to determine which consumers who are delinquent on their loan payments are likely to cure if called. In some variations the model purpose relates to applicant identification, and results of the model are used to determine whether a consumer applying for a loan is a real person or a synthetic identity. In some variations, the model purpose relates to business loan repayment, and results of the model are used to determine whether a business applying for a loan will repay the loan. In some variations, the model purpose is further refined by loan type, including: retail loans such as mortgage loans, refis, home equity loans, automotive loans, RV loans, powersports loans, credit cards, personal loans, student loans, and commercial loans including equipment loans, revolving lines of credit, accounts payable financing, and other loan types, retail or commercial, without limitation.

Embodiments herein provide at least one of: automatic feature selection, automatic parameter selection, automatic model generation, automatic model evaluation, automatic model documentation, automatic alternative model selection, automatic model comparison, automatic business analysis, automatic model execution, automatic model output explanation, and automatic model monitoring. In some variations, a machine learning platform (e.g., a cloud-based Software as a Service (SaaS) platform) provides such features related to model generation, analysis and validation and deployment and monitoring. In some variations, an automatically generated model (e.g., generated by the machine learning platform) is compared with a pre-existing model (e.g., a model currently in use by a user of the platform, but not generated by the platform), and results of the comparison are provided to a user system. In some variations the comparison includes economic analysis describing the expected business outcomes likely to arise from deploying a new model.

In some implementations, loan data identifying loan attributes (e.g., loan amount, loan term, collateral value, collateral attributes), credit data used to decide whether to grant the loans (e.g., number of inquiries, number of delinquencies, available credit and utilization, credit bureau attributes, trended attributes, etc), a credit policy, and loan outcomes for the loans made previously (e.g., repaid successfully, charged off/unpaid, or delinquent for a given number of days), are used to project a change in business metrics (such as loan volume, new customers, revenue from interest, loss rate, loss amount, gross margin, and net profit) resulting from using a model generated by the system for a specific business application (e.g. granting auto loans, credit line increase, etc.). In some implementations, the system automatically generates documentation, and the documentation identifies at least one of: selected features, reasons for choosing the selected features, how the model behaves in various circumstances, business projections and the like.

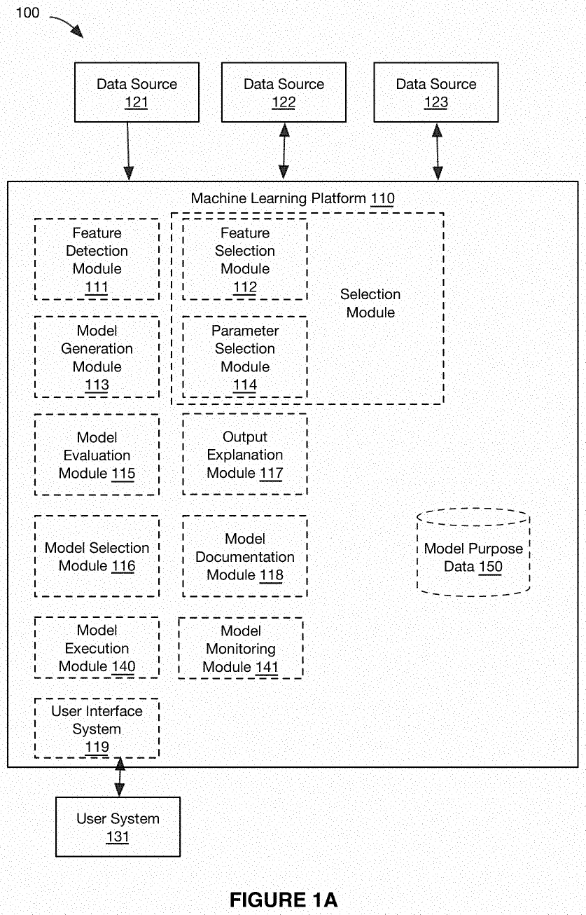

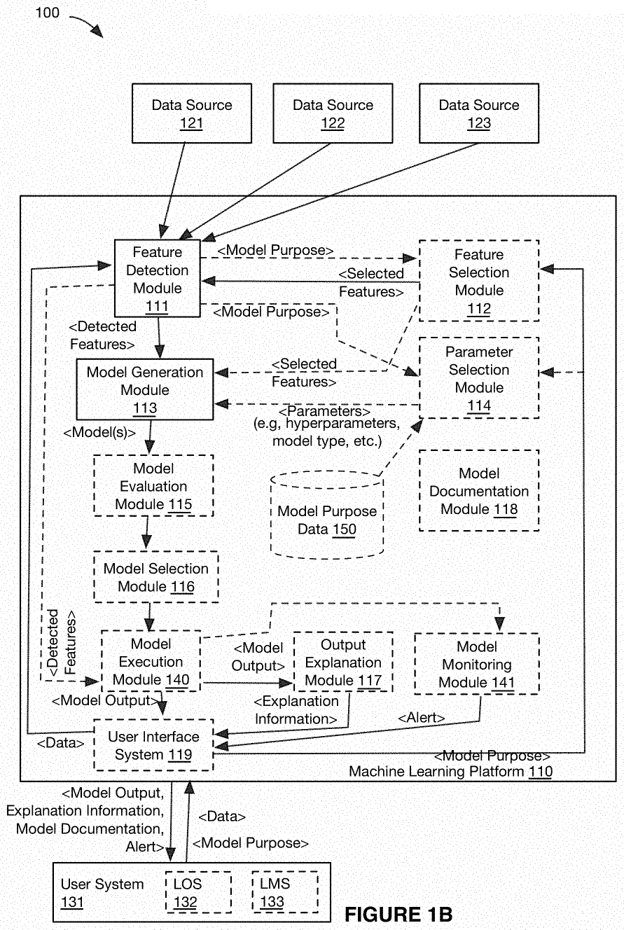

In some variations, the system is a machine learning platform (e.g., 110 shown in FIGS. 1A-B). In some variations, the method includes at least one of: accessing data, detecting features, generating at least one model, evaluating at least one model, executing at least one model, generating explanation information for at least one model, generating business analysis for at least one model, generating monitors and monitoring outputs for at least one model, generating documentation information for at least one model, and providing documentation for at least one model.

### 2. System

In some variations, a system (e.g., 100) includes at least one of: a feature detection module (e.g., 111), a feature selection module (e.g., 112), a model generation module (e.g., 113), a parameter selection module (e.g., 114), a model evaluation module (e.g., 115), a model selection module (e.g., 116), an output explanation module (e.g., 117), a model documentation module (e.g., 118), a user interface system (e.g., 119), a model execution module (e.g., 140), a model monitoring module (e.g., 141), and a data store (e.g., 150 that stores model purpose data.

In some variations, a system includes a machine learning platform 110. In some variations, the machine learning platform is an on-premises system. In some variations, the machine learning platform is a cloud-system. In some variations, the machine learning platform functions to provide software as a service (SaaS). In some variations, the platform 110 is a multi-tenant platform. In some variations, the platform 110 is a single-tenant platform

In some implementations, the system 110 is a machine learning platform (e.g., 110 shown in FIGS. 1A-B).

In some implementations, the system 110 includes at least one of: the user interface system 119 and the storage device 150. In some implementations, the system 110 includes at least one of the modules 111-118, 140 and 141 shown in FIGS. 1A and 1B.

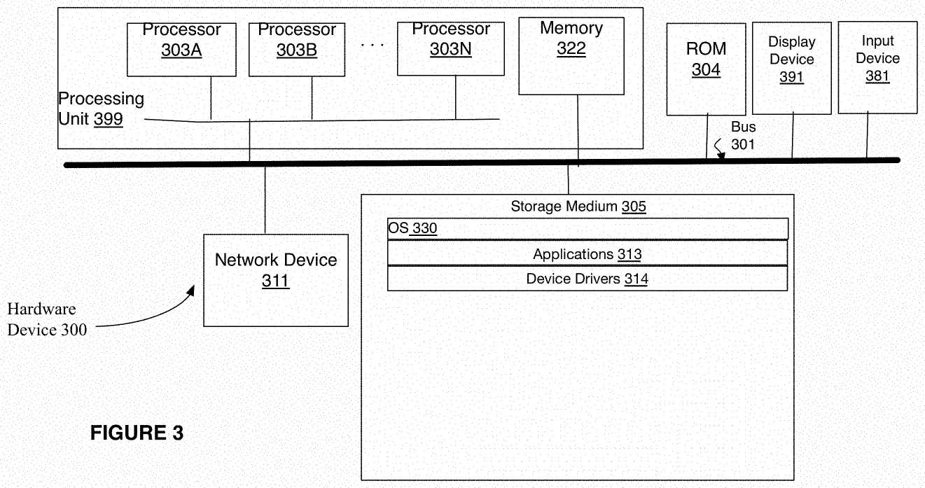

In some implementations, at least one component (e.g., 111-119, 140, 141, 150 of the system 110 is implemented as program instructions that are stored by the system 110 (e.g., in storage medium 305, memory 322 shown in FIG. 3) and executed by a processor (e.g., 303A-N shown in FIG. 3) of the system 110.

In some implementations, the system 110 is communicatively coupled to at least one data source (e.g., 121-123) via a network (e.g., a public network, a private network). In some implementations, the system 110 is communicatively coupled to at least one user system (e.g., 131) via a network (e.g., a public network, a private network).

FIG. 1B shows interactions of components of the system, in accordance with variations.

In some implementations, the storage device 150 stores model purpose data that identifies at least one of the following for each model purpose supported by the system: data sources, data sets, features, canonical features, a prediction target, model type, model parameters, hyperparameters. In some implementations, the storage device 150 includes model purpose data for an identified purpose, and the model purpose data is used to generate a model. For example, the model purpose data can be used to select features or select model parameters (type of model, prediction target, hyperparameters, etc.). In some implementations, model purpose data includes at least one model template. In some implementations, the template defines at least: canonical features to be used as model inputs; a model type; and a prediction target. In some implementations, the template defines each model of an ensemble, and an ensemble function. In some implementations, the template defines, for at least one model, input sources. Input sources can be the feature detection module in, which provides features to the model. Input sources can also include an output of another model. For example, a first model can generate an output value that is used as an input of a second model.

In some embodiments, the model purpose data is generated by domain experts (e.g., data scientists) having specific domain knowledge related to the identified purpose. For example, data scientists with experience with auto-loans can generate the model purpose data for an “auto loan originations” purpose, and this auto-loan model purpose data can be used to automatically generate models for “auto loan originations” purposes without further input from a data scientist.

In some variations, the feature detection module 111 functions to detect features from accessed data (e.g., data provided by a user system, data retrieved from a data source, etc.). In some variations, the accessed data includes raw data. In some implementations, the feature detection module 111 receives the accessed data via the user interface system 119. In some implementations, the feature detection module 111 receives data from at least one of a loan management system (LMS) of the user system (e.g., 133), a loan origination system (LOS) of the user system (e.g., 132), a data source (e.g., 121-123) (e.g., TransUnion, Equifax, Schufa, LexisNexis, RiskView credit bureau data with full tradeline information, Experian, Clarity, a central bank, Creditinfo, Compuscan, etc.).

In some variations, at least one component of the system 110 generates documentation information that documents processes performed by the component. In some variations, at least of the modules 111-118, 140 and 141 generates documentation information that describes processes performed by the module, and stores the generated documentation information in the model documentation module 118.

In some variations the documentation is based on analysis performed on the model (based on a model purpose, e.g., identified at S212 of the method 200) and includes business analysis determined by the model purpose. For example in auto lending, the business reporting output includes business outcomes based on switching from an old model to a new model. In variants, business outcomes include the projected default rate for the new model (holding approval rate constant). In other variants, business outcomes include one or more of: the projected approval rate holding risk constant, a charge off amount projection; an interest income projection; and a recovery projection based on asset information and a depreciation formula. In some variants, the projected business outcomes from multiple model variations are compared and summarized.

In some variations, the feature detection module in extracts canonical features from raw data accessed by the feature detection module in. In some implementations, each canonical feature is a semantically meaningful representation of information included in the accessed data. For example, the canonical feature “Number of Bankruptcies” can be extracted from raw data that includes features “TransUnion Count of Bankruptcies”, “Experian Count of Bankruptcies”, and “Equifax Count of Bankruptcies”. In other words, rather than treating “TransUnion Count of Bankruptcies”, “Experian Count of Bankruptcies”, and “Equifax Count of Bankruptcies” as individual features for purposes of model generation, the data from these features are used to determine a value for the canonical feature “Number of Bankruptcies”.

In some implementations, the feature detection module in extracts canonical features by applying predetermined transformation rules. In some implementations the transformation rules are selected automatically based on an identified model purpose and properties of the model development data. In some implementations, properties of the model development data are automatically determined based on analysis methods and statistics such as: percent of missing data, min, max, median, mean mode, skew, variance, and other statistics without limitation overall and over time. In other implementations the transformation rules are selected based on metadata associated with each column in the training data. In some implementations this metadata is computed based on predetermined rules. In other implementations the metadata is inferred based on statistics. For example if a variable with a low missing rate across 100,000 or more rows only takes on 5 distinct numeric values, the system (e.g, 100, 110) may infer that the variable is a categorical and select a transformation rule corresponding to “one hot” encoding, thereby generating a series of 5 Boolean flags to replace the original low-cardinal values with it's numeric in the modeling data. In other implementations the transformation rules are selected by indication of the user within a graphical user interface (e.g., provided by the user interface system 119 shown in FIG. 1B).

In some implementations, the feature detection module 111 extracts canonical features by performing any suitable machine learning process, including one or more of: supervised learning (e.g., using logistic regression, back propagation neural networks, random forests, decision trees, etc.), unsupervised learning (e.g., using an Apriori algorithm, k-means clustering, etc.), semi-supervised learning, reinforcement learning (e.g., using a Q-learning algorithm, temporal difference learning, etc.), and any other suitable learning style. In some implementations, the feature detection module 111 implements any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminant analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolutional network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. In some implementations, the feature detection module 111 can additionally or alternatively leverage: a probabilistic module, heuristic module, deterministic module, or any other suitable module leveraging any other suitable computation method, machine learning method or combination thereof. However, any suitable machine learning approach can otherwise be incorporated in the feature detection module 111. Further, any suitable model (e.g., machine learning, non-machine learning, etc.) can be used in detecting canonical features.

In some variations, the feature detection module 111 includes a plurality of feature detectors. In some variations, the feature detection module 111 includes a feature detector for each canonical feature.

In some variations, the feature detection module 111 detects all canonical features supported by the system 110. In some variations, the feature detection module 111 performs selective feature detection by detecting selected ones of the canonical features supported by the system 110. In some implementations, the feature detection module 111 selects canonical features for detection based on information identifying a model purpose. In some implementations, the feature detection module 111 selects canonical features for detection based on model purpose data associated with an identified model purpose. In some implementations, the feature detection module 111 selects canonical features for detection based on information received from a feature selection module (e.g., 112).

In some variations, the feature detection module 111 generates training data from data accessed by the feature detection module 111 (e.g., raw data, data provided by the user system, data retrieved from a data source, etc.). In some variations the feature detection module 111 automatically retrieves data from data sources based on information received from a user system (e.g., 131) via the user interface system 119. In some implementations, the information received by the feature detection module 111 from the user system via the user interface system 119 includes borrower personal data (name, address, government ID number), and information identifying selection of a model purpose. In some implementations, the feature detection module 111 retrieves training data records from various systems and data sources (e.g., 121-123) automatically based on the data received from the user system. In some implementations the data received from the user system includes borrower data for a sample of a population of user accounts identified by one or more of a demographic characteristic, an economic characteristic, and a credit characteristic.

In some implementations, the generated training data only includes columns for canonical features detected by the feature detection module 111, and respective values. In some implementations, the generated training data is used by the model generation module 113 to train a model (e.g., a model defined by model purpose data, e.g., 150, that corresponds to a model purpose identified by information by a user system, e.g., 131) during the model generation process. In some variations, the feature detection module 111 generates training data for a model template used by the model generation module 113, such that the training data includes at least one of: data for canonical features identified as inputs by the model template; and data for a canonical feature identified as a prediction target by the model template.

In some variations, the feature detection module 111 generates and stores documentation information that identifies at least one of: selected features, data sources accessed, time stamps for the accessed data, time stamps for detected canonical features, a description of the generated training data, data ranges, statistical data related to the detected features, name and description of the transformation applied to generate the canonical feature, and the like.

In some variations, the user interface system 119 provides a graphical user interface (e.g., a web interface). In some variations, the graphical user interface includes a series of modules organized by business function, for example: model development, model adoption, and model operations. In some variations the model adoption module includes submodules including model risk, model compliance, and business impact. In some variations, the user interface system 119 provides a programmatic interface (e.g., an application programming interface (API)) to access intermediate outputs, and final outputs from the system (e.g., no). In some variations, the user interface system 119 creates audit logs and reports that reflect model variations and detailed change logs. In some variations, the user interface system 119 provides role-based access in which specific users only have access to certain modules. In some variations, the user interface system 119 is pre-integrated with other systems such as loan origination systems (LOS) (e.g., 132), data aggregators and credit bureaus, so that models can be developed, validated and published directly from the user interface system 119=. In this way, new model variations can be more easily tested and deployed where they can generate business impact. In some variations, the user interface system 119 includes a monitoring dashboard that includes business impact monitoring, model monitoring, and system monitoring dashboards. In variants, the business impact monitoring dashboard includes business metrics such as approval rate, delinquency rate, vintage loss curves, charge off value, interest income value, and comparison to prior models. In variants, the system 110 automatically gathers new data on the unfunded population in order to perform an automated ROI comparison between a prior model and a new model based on the performance loans given by other lenders to the unfunded population.

In some variations, the feature selection module 112 functions to select one or more canonical features based on information identifying a model purpose. In some implementations, the feature selection module 112 receives the information identifying a model purpose from a user interface system (e.g., 119). In some variations, the feature selection module 112 selects one or more canonical features based on model purpose data associated with the identified model purpose.

In some variations, the feature selection model 112 incorporates cost information to select the set of data sources that deliver the maximum profit.

In some variations, the feature selection module 112 and the parameter selection module 114 are included in a selection module.

In some variations, the model generation module 113 generates at least one model based on information identifying a model purpose and the training data (e.g., generated by the feature detection module, accessed from a data store, accessed from a data source, etc.). In some variations, the model generation module 113 generates at least one model based on model purpose data (e.g., stored in 150) associated with an identified model purpose. In some variations, the model generation module 113 generates at least one model based on information (e.g., a model template) received from a parameter selection module (e.g., 114). In some variations, the model generation module 113 generates at least one model based on information received from a feature selection module (e.g., 112). In some implementations, the model purpose data identifies a model template. In some implementations, each model template defines a model that uses canonical features detectable by the feature detection module 111. In some implementations, the model generation model 113 generates a model that uses only canonical features detectable by the feature detection module 111. In this manner, generation of models can be constrained to models that use canonical features.

By virtue of using a feature detection module (e.g., 111) that processes raw data to generate data in a canonical format, the format and identities of canonical features usable by the model generation module (e.g., 113) can be known in advance, thereby enabling the generation of model templates that can be used to generate new models.

In some variations, the model generation module 113 uses data (training data) output by the feature detection module 111 to train at least one model generated by the model generation module 113.

In some variations, the model generation module 113 functions to generate models using any suitable machine learning process, including one or more of: supervised learning (e.g., using logistic regression, back propagation neural networks, random forests, decision trees, etc.), unsupervised learning (e.g., using an Apriori algorithm, k-means clustering, etc.), semi-supervised learning, reinforcement learning (e.g., using a Q-learning algorithm, temporal difference learning, etc.), and any other suitable learning style. In some implementations, generated models can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminant analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolutional network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. In some implementations, a generated model can additionally or alternatively leverage: a probabilistic module, heuristic module, deterministic module, or any other suitable module leveraging any other suitable computation method, machine learning method or combination thereof. However, any suitable machine learning approach can otherwise be incorporated in a generated model. Further, any suitable model (e.g., machine learning, non-machine learning, etc.) can be generated.

In some variations, the feature selection module 112 functions to select features to be detected by the feature detection module 111. In some variations, the feature selection module 112 functions to select features to be used by the model generation module 113. In some implementations, the feature selection module 112 selects features based on information identifying a model purpose (e.g., information received via the user interface system 119). In some implementations, the feature selection module 112 selects features based on a model template that identifies at least one of input value features and prediction target features to be used during model generation.

In some variations, the parameter selection module 114 functions to select parameters to be used during model generation (e.g., by the model generation module 113). In some implementations, the parameter selection module 114 selects parameters based on information identifying a model purpose (e.g., information received via the user interface system 119). In some implementations, the parameter selection module 114 selects parameters based on a model template that identifies parameters to be used during model generation. In some implementations, the parameter selection module 114 selects at least one model template that identifies parameters to be used during model generation (e.g., by the model generation module 113). In some implementations, parameters included at least one of: data sources, data sets, features, canonical features, a prediction target, model type, model parameters, and hyperparameters.

In variations, the parameter selection module 114 determines the parameters used to train the model and the model generation module 113 produces a model based on training data and the selected parameters. In some variations, the parameter selection module 114 enumerates various parameters and trains a series of models, then further selects the parameters that results in the maximum model performance on a testing dataset. In variations, the model performance is measured based on AUC (area under the curve), max K-S and other statistics. In other variations, model performance is measured based on economic outcomes as determined by the model purpose and an economic analysis method associated with the selected purpose. A search process for selecting model parameters can use any common search method such as grid search, bayesian search, and the like. The system (e.g., 100, 110) disclosed herein conventional systems by making use of the model purpose to apply economic analysis to guide the feature selection process (performed by the feature selection module 112) and model parameter search process (performed by the parameter selection module 114), which allows the system to produce and document models that yield higher economic performance (not just higher statistical performance). In lending, it is often the case that the economic consequence of a false positive is different than for false negatives. As such the disclosed system provides a new and useful way of incorporating this asymmetry into the model development process based on a realistic economic model corresponding to the specific model purpose (e.g., automotive originations vs credit card originations). In an example, for the specific purpose of auto lending, a false negative could correspond to the case where the model predicts the user will repay when in fact they don't. In this case the cost to the lender is the value of the outstanding loan balance minus the value of the repossessed vehicle at auction minus costs. For bank cards (credit cards) there is no collateral (car to repossess) and so in embodiments, the economic consequences of a false negative are calculated differently, e.g., based on the outstanding balance, the cost of collections and the amount collected. Likewise in embodiments, for the model purpose of bankcard originations, the value of a true negative (repayment) might be based on the expected customer LTV (interest income over the average tenure and average bankcard balance for the proportion of customers that maintain balances in months). For auto loans the value of a true negative (repayment) might be based on the interest income for the one specific loan. These values can be used to produce weighted statistics such as a weighted F measure and a weighted AUC that incorporate the expected value of a true positive, true negative, false positive and false negative into the calculation vs assuming these are valued equally. Any suitable statistic may be used for this purpose. In this way, during the model development process, the parameter selection module 114 can incorporate different expected values for true positives, true negatives, false positives and false negatives into the process of selecting the model parameters.

In some variations, the model documentation module 118 generates model documentation based on data stored by the model documentation module (and optionally data received from other modules of the system 110 (e.g., 111-118, 140, 141). In some implementations, the model documentation module 118 automatically generates Model Risk Management (MRM) reports based on data received and/or stored by the model documentation module 118.

In some variations, the model documentation module 118 stores facts about variables and features. In some variations, the model documentation module 118 stores information that indicates the type of feature (numeric, categorical, text, image), where a variable came from (e.g., which database, which query, when retrieved), which variables contribute to a feature (e.g., average of which two variables, maximum within which column), how a feature was calculated (in human-readable language, e.g., English, and in computer-executable code), descriptive statistics, visualizations, and summaries, including: cardinality, histograms, distributions, analyses, principal components, anomalies, missing data, time-series, comparisons, a feature's ideal value, and protected class proxies (e.g., variables, features, or combinations of variables and features that can identify a protected class). In some variations, the model documentation module 118 stores facts about the model development process, including who uploaded the data to develop the model, when it was uploaded, what changes were made to model inputs, parameters, and the like, by whom and when, comments added by model reviewers during the model review process, and other material information related to the model development process as orchestrated by a user interface.

In some variations, the model documentation module 118 stores facts about a model, including, without limitation: the training and validation data sets, the modeling method/machine learning algorithm used, the model tuning parameters, model scores, model evaluation and analysis. In some variations, the model documentation module 118 stores information that indicates lists of submodels in an ensembled model, model type, input feature list, and hyperparameters of a model or submodel, the parameter selection method and results, model performance metrics, feature contributions of a model or submodel. In some variations the feature contributions are linked to the feature descriptions and descriptive statistics and metadata. In some variations, the model documentation module 118 stores information that indicates (for an ensemble model) an ensembling method, submodel, weights of submodels, and scoring functions for submodels and the scoring function for the ensemble. In some variations, the model documentation module 118 stores information related to the distribution of model scores and performance statistics overall and by segment. In other variations, the model documentation module 118 stores information about the feature contributions of the ensemble. In some variations, the model documentation module 118 includes a knowledge repository, as described in U.S. patent application Ser. No. 16/394,651 (“SYSTEMS AND METHODS FOR ENRICHING MODELING TOOLS AND INFRASTRUCTURE WITH SEMANTICS”), filed 25 Apr. 2019, the contents of which is incorporated herein.

In some variations, the model evaluation module 115 functions to evaluate at least one model generated by the model generation module 113. In some variations, the model evaluation module 115 performs accuracy analysis for at least one model generated by the model generation module 113. In some variations, the accuracy analysis includes computing a max K-S, Gini coefficient, or AUC statistic on a test data set. In some variations, the test data set is an out-of-time hold-out data set (a data set from a period after the model development data in time). In some variations the model evaluation module 115 calculates statistics on subsets of the test data, for example, K-S and AUC by day, week, month. In some variations, dispersion metrics are calculated for these accuracy metrics over time, such as the variance in AUC week over week. In some variations, the model evaluation module 115 performs economic analysis comparing a model with another model or method and estimating the economic impact of adopting a new model based on the model purpose (as described herein with respect to the parameter selection module 114). In some variations, the model evaluation module 115 performs fair lending disparate impact analysis for at least one model generated by the model generation module 113. In some variations, the model evaluation module 115 performs fair lending disparate impact analysis using a method described in U.S. application Ser. No. 16/822,908 (“SYSTEMS AND METHODS FOR MODEL FAIRNESS”), filed 18 Mar. 2020, the contents of which is incorporated herein. In some variations, the evaluation module 115 stores evaluation results in the model documentation module 118.

In some variations, the model selection module 116 selects at least one model generated by the generation module 113, based on results of the model evaluation module 115. For example, the generation module 113 can generate several models, the evaluation module can evaluate each model based on fair lending disparate impact analysis, accuracy analysis, and economic impact analysis, and the selection module 116 can select a model that satisfies constraints for economics, accuracy and fairness (e.g., constraints provided via the user interface system 119). In some variations, the model selection module 116 stores selection results (and optionally a rationale for a selection, e.g., economics, accuracy and fairness analysis results used in the selection) in the model documentation module 118.

In some variations, the model execution module 140 functions to execute at least one model generated by the model generation module 113. In some variations, the model execution module 140 executes at least one model generated by the model generation module 113 by using data output by the feature detection module 111 as input data. In some implementations, each model executed by the model execution module 140 receives input data from the feature detection module 111. In this manner, the feature detection module in performs pre-processing of raw data used during model execution. In some variations, during model execution, raw input data is received by the feature detection module in, the feature detection module in processes the raw data, and this processed data is provided as input to the model (or models) being executed by the model execution module 140.

In some variations, the output explanation module 117 functions to generate explanation information for output generated by a model being executed by the model execution module 140. In some variations, the output explanation module 117 functions to generate explanation information by performing a method described in U.S. patent application Ser. No. 16/297,099, filed 8 Mar. 2019, entitled “SYSTEMS AND METHODS FOR PROVIDING MACHINE LEARNING MODEL EXPLAINABILITY INFORMATION BY USING DECOMPOSITION”, by Douglas C. Merrill et al, the contents of which is incorporated herein. In some variations, the output explanation module 117 functions to generate explanation information by performing a method described in U.S. patent application Ser. No. 16/688,789 (“SYSTEMS AND METHODS FOR DECOMPOSITION OF DIFFERENTIABLE AND NON-DIFFERENTIABLE MODELS”), filed 19 Nov. 2019, the contents of which is incorporated by reference. In some variations, the output explanation module 117 functions to generate explanation information by performing a method described in U.S. application Ser. No. 16/822,908 (“SYSTEMS AND METHODS FOR MODEL FAIRNESS”), filed 18 Mar. 2020, the contents of which is incorporated herein.

In some variations, the explanation module 117 generates FCRA Adverse Action Reason Codes for output generated by a model being executed by the model execution module 140.

In some variations, the monitoring module 141 functions to monitor performance of at least one model in production. In some variations, the monitoring module 141 monitors by performing a method described in U.S. patent application Ser. No. 16/394,651 (“SYSTEMS AND METHODS FOR ENRICHING MODELING TOOLS AND INFRASTRUCTURE WITH SEMANTICS”), filed 25 Apr. 2019, the contents of which is incorporated herein. In some variations, the monitoring module 141 performs monitoring based on at least one of: data stored by the documentation module 118, data provided by the execution module 140, and data provided by the explanation module 117.

In some variations, the monitoring module 141 functions to monitor the economic performance of at least one model in production. In variations, economic performance is computed based on the model purpose and performance data gathered from the customer's systems and includes approval rate, projected default rate, projected losses, projected profits, actual default rate, actual losses, and actual profits. In other variations, economic performance monitoring includes calculating counterfactual scenarios considering what would have happened to if the customer had left their original model in production. In variants, the method of calculating counterfactual economic scenarios for models with loan origination purposes includes retrieving data from credit bureaus and other data sources about applications for loans that were rejected by the new model but that would have been accepted by an old model. Other counterfactual economic analysis methods are employed for models with different purposes. In this way the monitoring method disclosed herein improves upon the state of the art by incorporating knowledge of the model purpose and data collected during the model development and evaluation process to produce meaningful business results monitoring outputs for the plurality of model purposes the system supports.

### 3. Method

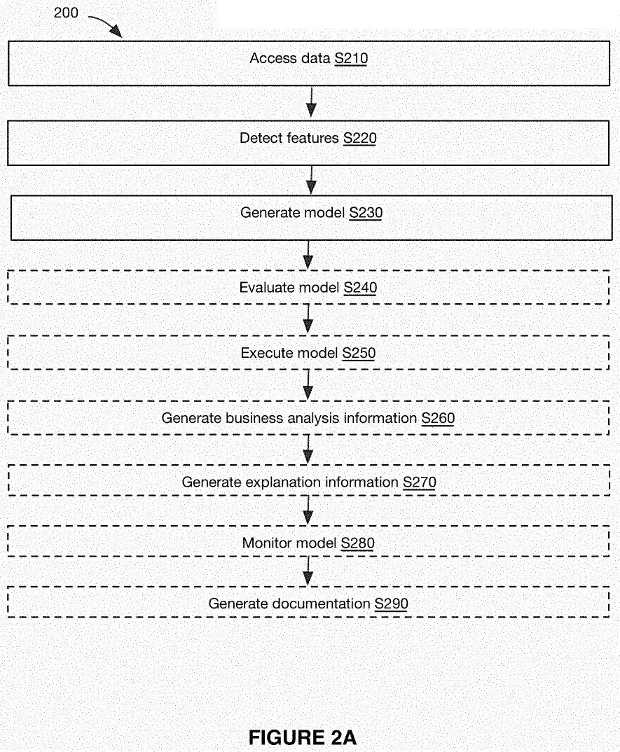

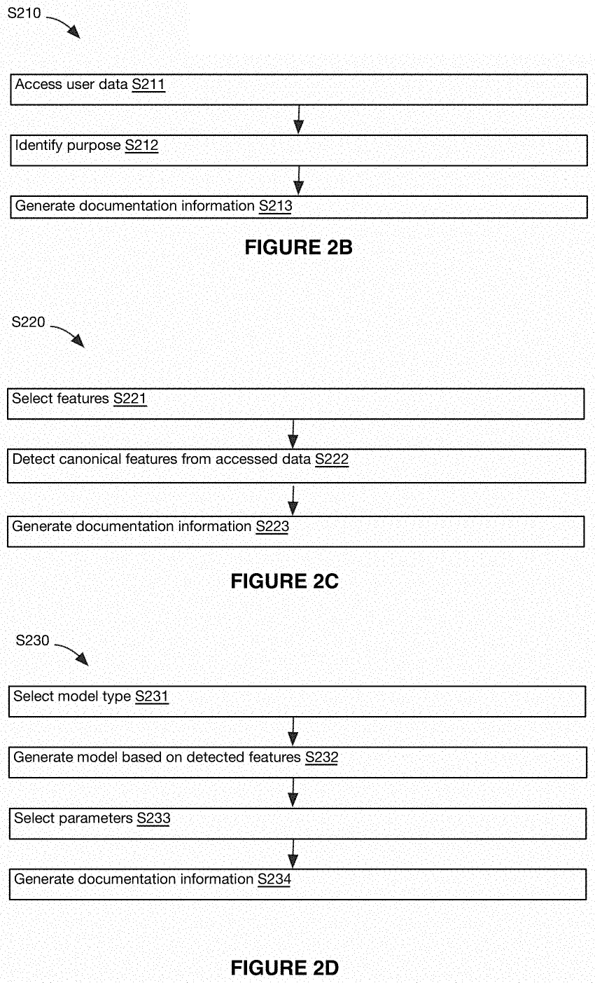

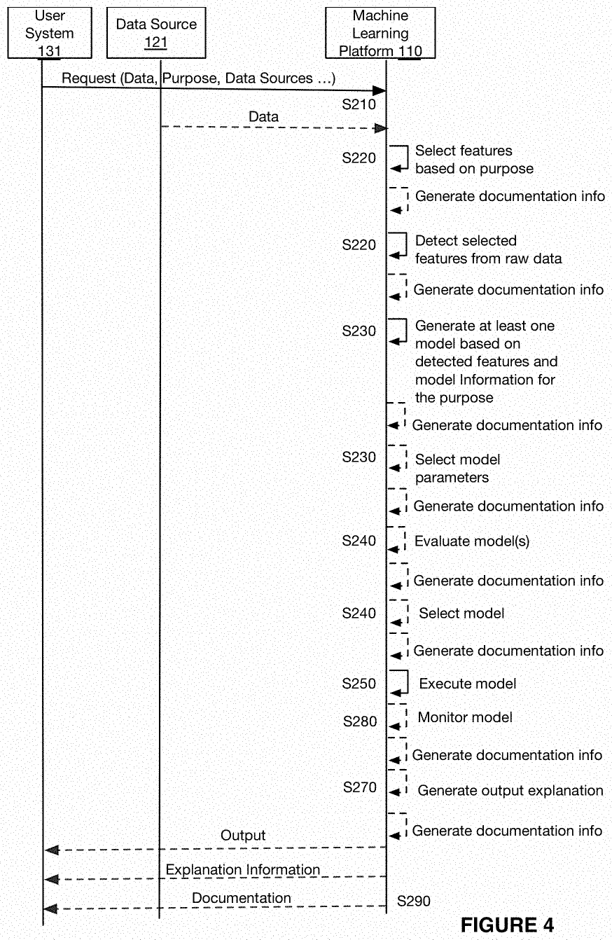

As shown in FIG. 2A, a method 200 includes at least one of: accessing data (S210); detecting features (S220); generating at least one model (S230); evaluating at least one model (S240); executing at least one model (S250); generating business analysis information (S260); generating explanation information for at least one model (S270); monitoring at least one model (S280); and generating documentation information for at least one model (S290). FIG. 4 shows a schematic representation of an implementation of the method 200.

In some variants, at least one component of the system 100 performs at least a portion of the method 200.

In some variations, the machine learning platform 110 performs at least a portion of the method 200. In some variations, at least one component of the system 110 performs at least a portion of the method 200.

In some implementations, a cloud-based system performs at least a portion of the method 200. In some implementations, a local device performs at least a portion of the method 200.

In some variations, accessing data S210 functions to access data from at least one of a user system (e.g., 131-133) and a data source (e.g., 121-123) that is external to a user system (e.g., a credit bureau system, etc.). In some variations, the feature detection module 111 performs at least a portion of S210. In some variations, the user interface system 119 performs at least a portion of S210.

Accessing data S210 can include at least one of: accessing user data S211, identifying a purpose S212 and generating documentation information S213 shown in FIG. 2B.

Accessing user data S211 can include accessing user data from a user system (e.g., 131-133 shown in FIG. 1B), or a data source identified by a user system.

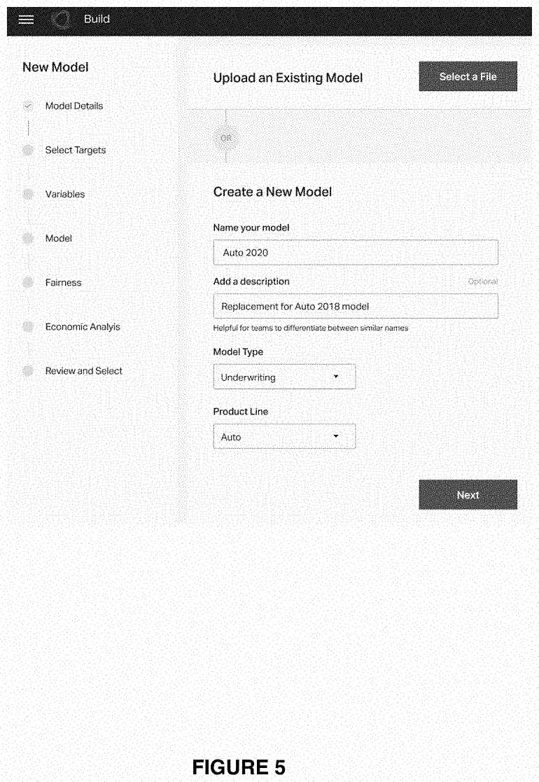

Identifying a purpose S212 functions to identify a purpose for a model to be generated by the system (e.g., 110). In some variations, the system 110 (e.g., user interface system 119) identifies the purpose from information provided by a user system (e.g., 131). In variants, the system 110 receives information identifying user selection of a model purpose via a user interface system (e.g., 119). FIG. 5 shows an exemplary user interface that receives user input for a model purpose (“Model Type”, “Product Line”). In some variations, the system 110 identifies the purpose by processing data used to generate a model (e.g., training data). For example, a system 110 can receive data from a Loan Origination System (e.g., 132), and process the received data to identify a model purpose. The Loan Origination Data can identify the data as being data for an auto loan, and the system 110 can automatically identify the model purpose as “auto loan”. For example, the data can include data that identifies a car that is subject to the loan, and this information can be used to infer that the data relates to an “auto loan”. However, any suitable process for identifying a model purpose can be performed by the system 110.

In variants, identifying a purpose at S212 includes accessing model purpose data that is stored in association with the identified model purpose. In some implementations, the model purpose data is accessed (directly or indirectly) from the model purpose data store (e.g., 150).

Generating documentation S213 functions to generate documentation information related to processes performed during S210. In variants, the documentation information is managed by the model documentation module 118.

In some variations, detecting features S220 includes generating training data from the data accessed at S210. In some variations, detecting features S220 includes detecting features, and generating training data that includes the detected features. In some variations, the feature detection module 111 performs at least a portion of S220.

Detecting features S220 can include at least one of: selecting features S221, detecting canonical features from accessed data S222, and generating documentation information S223, as shown in FIG. 2C.

Selecting features S221 functions to select features to be detected by the system 110 (e.g., by using the feature detection module 111). In some implementations, the feature selection module 112 performs feature selection, as described herein with respect to the feature selection module 112. In some implementations, canonical features are selected at S221. In some implementations, the features are selected (e.g., by the feature selection module 112) based on model purpose data (e.g., stored in 150) associated with the purpose identified at S212. In some implementations, the model purpose data includes a model template, as described herein.

Detecting canonical features S222 functions to detect at least one canonical feature from data accessed at S210. In some variations, the feature detection module 111 performs S222 (as described herein with respect to the feature detection module 111). In some variations, S222 includes detecting canonical features selected at S221. In some variations, S222 includes detecting only canonical features selected at S221. In some implementations, a plurality of feature detectors are used to perform S222. In some variations, S222 includes generating training data from the detected canonical features.

Generating documentation information at S223 functions to generate documentation information related to processes performed during S220. In some implementations, the documentation information is managed by the model documentation module 118.

Generating a model S230 can include at least one of: selecting a model type S231, generating a model based on detected features S232, selecting parameters S233, and generating documentation information related to model generation S234, as shown in FIG. 2D. In some variations, the model generation module 113 performs at least a portion of S230.

Generating a model S230 can include: generating a model based on parameters identified by model purpose data (e.g., a model template) (e.g., stored in 150) associated with the purpose identified at S212; and training the model by using training data generated at S220.

In some variations, selecting a model type at S231 includes selecting the model type based on model purpose data (e.g., a model template) (e.g., stored in 150).

In some variations, generating the model based on detected features S232 includes defining the model to include as input features, only features detectable by the feature detection module 111. In some variations, S232 includes defining the model to include as a prediction target, only features detectable by the feature detection module 111.

In some variations, selecting model parameters S233 includes selecting at least one of hyperparameters, feature weights, and the like. In some variations, the model parameters are selected based on model purpose data (e.g., a model template) (e.g., stored in iso). In some variations, the model parameters are selected based on model economic analysis methods associated with the model purpose data (e.g., stored in iso). In an example, model purpose data identifies, for at least one model purpose, model parameters associated with economic analysis methods that will be performed for the model generated for the model purpose. For example, for an auto loan origination purpose, the model purpose data identifies model parameters that enable business analysis related to auto loan origination.

Generating documentation information at S234 functions to generate documentation information related to processes performed during S230. In some implementations, the generated documentation information is managed by the model documentation module 118.

In variants, the model(s) generated at S230 can be any suitable type of model. Models generated at S230 can include differentiable models, non-differentiable models, and ensembles (which can include any combination of differentiable and non-differentiable models, ensembled using any suitable ensembling function).

In a first example, a model generated at S230 includes a gradient boosted tree forest model (GBM) that outputs base scores by processing base input signals.

In a second example, a model generated at S230 includes a gradient boosted tree forest model that generates output by processing base input signals. The output of the GMB is processed by a smoothed Empirical Cumulative Distribution Function (ECDF), and the output of the smoothed ECDF is provided as the model output (percentile score).

In a third example, a model generated at S230 includes sub-models (e.g., a gradient boosted tree forest model, a neural network, and an extremely random forest model) that each generate outputs from base input signals. The outputs of each sub-model are ensembled by using a linear stacking function to produce a model output (percentile score).

In a fourth example, a model generated at S230 includes sub-models (e.g., a gradient boosted tree forest model, a neural network, and an extremely random forest model) that each generate outputs from base input signals. The outputs of each sub-model are ensembled by using a linear stacking function. The output of the linear stacking function is processed by a smoothed ECDF, and the output of the smoothed ECDF is provided as the model output (percentile score).

In a fifth example, a model generated at S230 includes sub-models (e.g., a gradient boosted tree forest model, and a neural network) that each generate outputs from base input signals. The outputs of each sub-model (and the base signals themselves) are ensembled by using a deep stacking neural network. The output of the deep stacking neural network is processed by a smoothed ECDF, and the output of the smoothed ECDF is provided as the model output (percentile score).

However, the model can be any suitable type of model, and can include any suitable sub-models arranged in any suitable configuration, with any suitable ensembling and other processing functions.

Evaluating the model S240 functions to evaluate a model generated at S230, generate evaluation information for the model. In some variations, the model evaluation module 115 performs at least a portion of S240.

In some variations, evaluating the model at S240 includes performing accuracy analysis for at least one model generated at S230, as described herein. In variants, the evaluation information includes results of the accuracy analysis.

In some variations, evaluating a model (S240) includes generating economic analysis information for at least one model generated at S230. In some variations, the economic analysis information is generated based on the model purpose and a comparison of models or methods. In some variations, generating the economic analysis information includes computing a value for at least one business metric for the model generated at S230. In some implementations, the model purpose data (accessed at S212) defines the each business metric associated with the model purpose, and values for these business metrics are computed (at S240) for the model generated at S230. In some implementations, a value for at least one business metric is also computed for an original model used for the purpose identified at S212. In some implementations, business metric values for the original model are compared with corresponding business metric values for a model generated at S230. In some implementations, results of the comparison between the business metric values for the original model and the business metric values for the model generated at S230 are included in the generated economic analysis information.

In an example, performing economic analysis at S240 includes generating economic analysis information identifying projected values for business metrics for a deployed instance of a model generated at S230. Example business metrics projected at S240 include one or more of: loan volume, new customers, customer acquisition cost, revenue from interest, loss rate, loss amount, gross margin, and net profit.

For example in auto lending, the business reporting output includes business outcomes based on switching from an old model to a new model. In variants, business outcomes include the projected default rate for the new model (holding approval rate constant). In other variants, business outcomes include one or more of: the projected approval rate holding risk constant; a charge off amount projection; an interest income projection; and a recovery projection based on asset information and a depreciation formula. In some variants, the projected business outcomes from multiple model variations are compared and documented.

In some variations, evaluating a model at S240 includes performing fair lending disparate impact analysis for at least one model generated at S230, as described herein. In variants, the evaluation information includes results of the fair lending disparate impact analysis and includes fairness metrics and business outcomes under various scenarios. The scenarios help the user choose which model to select and document the reasons for their selection via a user interface (e.g., 119).

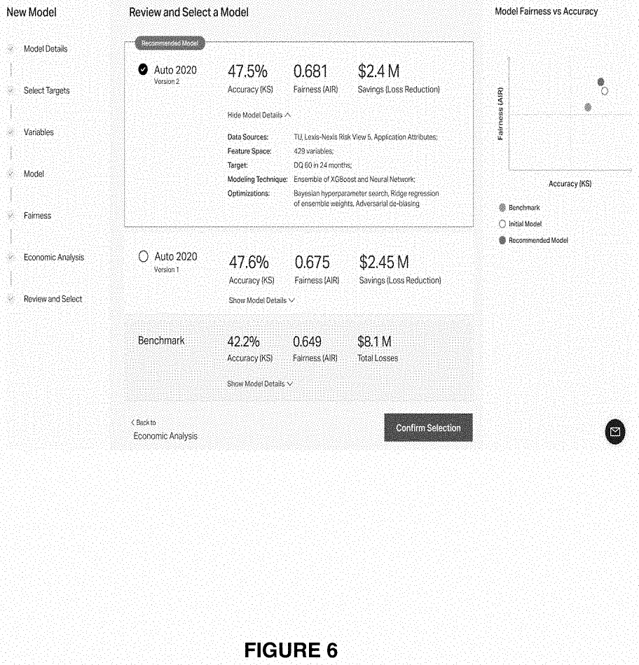

In some variations, evaluating a model S240 includes selecting (e.g., by using the model selection module 116) at least one model generated at S230, based on model evaluation results generated at S240. FIG. 6 shows an exemplary user interface for selecting a model (“Auto 2020 Version 2”), based on model evaluation results (“Accuracy”, “Fairness”, “Savings (Loss Reduction)”) generated at S240.

In some variations, evaluating a model at S240 includes generating documentation information related to processes performed during S240. In variants, the documentation includes the generated evaluation information. In some implementations, the documentation information is managed by the model documentation module 118.

Executing a model at S250 functions to execute a model generated at S230. In some variations, the model execution module 140 performs at least a portion of S250. In some variations, S250 includes executing at least one model generated at S230. In some variations, S250 includes executing at least one model generated by the model generation module 113 by using data output by the feature detection module 111 as input data. In some implementations, each model executed at S250 receives input data from the feature detection module in. In this manner, the feature detection module in performs pre-processing of raw data used during model execution (at S250). In some variations, during model execution, raw input data is received by the feature detection module in, the feature detection module in processes the raw data, and this processed data is provided as input to the model (or models) being executed at S250.

In some variations, S250 includes generating at least one model output by using at least one model generated at S230. In variations, S250 includes generating model outputs for the purposes of validating the model outcomes for a user-specified scenario, such as a change in applicant specified by the user via a user interface.

In some variations, S250 includes generating documentation information related to processes performed during S250. In some implementations, the documentation information is managed by the model documentation module 118.

Generating business analysis information at S260 functions to generate business analysis information by using model output generated by the deployed model (e.g., at S250). In variants, generating business analysis information includes identifying one or more of: approval rate, delinquency rate, vintage loss curves, charge off value, and interest income value, related to loans originated by using output generated by the deployed model (or models) at S250. In variants, model purpose information (accessed at S212) defines at least one business analysis process, and the system (e.g., no) generates the business analysis information system (at S260) by performing at least one business analysis process defined by the accessed model purpose information. In this manner, business analysis is performed in accordance with the identified model purpose (identified at S212), and business analysis can be tailored to a specific model purpose. In variants, the user provides business analysis inputs via a user interface. The system provides good default values for business inputs based on the business purpose and the model development data, based on a set of predetermined rules or a model. The user can modify the default values for business inputs based on their specific business circumstances, for example, by providing an average total cost of a loan default, an average interest income, a customer lifetime value, and other values and costs that enter into the calculation of various business metrics such as profitability. The documentation model reflects the method and assumptions selected by the user in the documentation.

S270 functions to generate explanation information for model output generated at S250. In some variations, the output explanation module 117 performs at least a portion of S270. In some variations, S270 includes generating explanation information as described herein with respect to the output explanation module 117. In some variations, S270 includes generating FCRA Adverse Action Reason Codes for output generated at S250. In some variations S260 includes generating FCRA Adverse Action Reason Codes for output generated at S250 based on a mapping from individual input features to more general reason codes and aggregating contribution of individual input features belonging to the same reason code.

In some variations, S270 includes generating documentation information related to processes performed during S270. In some implementations, the documentation information is managed by the model documentation module 118.

S280 functions to monitor at least one model being executed at S250. In some variations, the model monitoring module 141 performs at least a portion of S280. In some variations, S280 includes monitoring performance of at least one model in production, as described herein with respect to the monitoring module 141. In some variations, S280 functions to detect at least one of feature drift, unexpected inputs, unexpected outputs, population stability, unexpected economic performance, and the like. In some variations, S280 functions provide an alert to at least one system (e.g., 131-133 shown in FIG. 1B) in response to detecting at least one of feature drift, unexpected inputs, unexpected outputs, population stability, economic performance, and the like. In variations, S280 assesses the importance of monitoring outputs based on properties of the model development data and a model purpose. In some variations the criteria for assessing the importance of monitoring outputs is based on a model. In variations, the importance assessment is used to determine whether to send an alert to a user indicating an important monitoring output was generated that warrants further attention. In this way, the user may take corrective action when a high incidence of feature drift, or unexpected economic performance occurs, for example by rebuilding the model based on new data or observations. In variations, an alert leads to a user interface that guides the user through a process to remediate the conditions causing the alert. In variations, this process is configured based on a model purpose, properties of the model development data and business analysis inputs.

In some variations, generating documentation at S290 includes providing at least a portion of the document information generated during performance of the method 200 (e.g., at S210, S220, S230, S240, S250, S260 and S270). In some implementations, the documentation includes evaluation information generated at S240. In some implementations, the documentation includes business analysis information generated at S250. In some implementations, the documentation includes explanation information generated at S270. In some implementations, the documentation includes monitoring information generated at S280. In some variations, the model documentation module 118 performs at least a portion of S290. In some variations, the user interface system 119 performs at least a portion of S290. In some variations, S290 functions to provide a Model Risk Management (MRM) report to a user system (e.g., 131).

In some variations, the user interface system 119 provides the user system 131 with information identifying loan origination costs and profits resulting from loan generation and management by using an existing system or process of the user system 131, and information identifying loan origination costs and profits predicted by using a model generated by the system 110. For example, the system 110 can access loan origination data (and related data) from the user system (e.g., from the LOS 132), identify actual losses from loan defaults, determine whether the model generated by the system 110 would have approved the loans resulting in actual losses, and determine a predicted loan default loss that would have been realized had the model (generated by the system no) been used to approve the loans processed by the user system. In this manner, an entity managing the user system can learn whether use of the model generated by the platform no would have reduced loan default losses. As another example, the system no can identify loan applications that were denied by the entity but would have been approved by using the model, and predict profits and defaults associated with approving these loans. In this manner, the entity can learn whether the model can be used to approve more loans (resulting in increased profit), while at the same time managing default risk, thereby resulting in increased profit.

In variations, the user interface system 119 provides functions that enable model risk and compliance teams to comment on the Model Risk Management Report and provide written feedback which is recorded and categorized by severity, and automatically routed to the user that is preparing the model for review. In variations, this feedback is further captured and managed in the model documentation module 118. In variations, a model review process is facilitated, in which multiple stakeholders review the model and provide feedback for the user preparing the model for review. In other variations, this feedback is used to modify the model. In some variations, the user interface system 119 facilitates model modifications including dropping an input feature, adding a monotonicity constraint, selecting different training data, modifying an adverse action reason code mapping, and the like. Such model modifications are again reflected in the model documentation module 118 and in the model documentation.

In some variations, the system 110 is implemented by one or more hardware devices. FIG. 3 shows a schematic representation of architecture of an exemplary hardware device 300.

In some variations, a hardware device (e.g., 300 shown in FIG. 3) implementing the system no includes a bus 301 that interfaces with the processors 303A-N, the main memory 322 (e.g., a random access memory (RAM)), a read only memory (ROM) 304, a processor-readable storage medium 305, and a network device 311. In some variations, the bus 301 interfaces with at least one of a display device 391 and a user input device 381.

In some variations, the processors 303A-303N include one or more of an ARM processor, an X86 processor, a GPU (Graphics Processing Unit), a tensor processing unit (TPU), and the like. In some variations, at least one of the processors includes at least one arithmetic logic unit (ALU) that supports a SIMD (Single Instruction Multiple Data) system that provides native support for multiply and accumulate operations.

In some variations, at least one of a central processing unit (processor), a GPU, and a multi-processor unit (MPU) is included.

In some variations, the processors and the main memory form a processing unit 399. In some variations, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip).

In some variations, the processing unit includes at least one arithmetic logic unit (ALU) that supports a SIMD (Single Instruction Multiple Data) system that provides native support for multiply and accumulate operations. In some variations the processing unit is a Central Processing Unit such as an Intel processor.

In some variations, the network adapter device 311 provides one or more wired or wireless interfaces for exchanging data and commands. Such wired and wireless interfaces include, for example, a universal serial bus (USB) interface, Bluetooth interface, Wi-Fi interface, Ethernet interface, near field communication (NFC) interface, and the like.

Machine-executable instructions in software programs (such as an operating system, application programs, and device drivers) are loaded into the memory (of the processing unit) from the processor-readable storage medium, the ROM or any other storage location. During execution of these software programs, the respective machine-executable instructions are accessed by at least one of processors (of the processing unit) via the bus, and then executed by at least one of processors. Data used by the software programs are also stored in the memory, and such data is accessed by at least one of processors during execution of the machine-executable instructions of the software programs. The processor-readable storage medium is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like.

The system and methods of the preferred embodiments and variations thereof can be embodied and/or implemented at least in part as a machine configured to receive a computer-readable medium storing computer-readable instructions. In some variations, the instructions are executed by computer-executable components integrated with the system and one or more portions of the processor and/or the controller. The computer-readable medium can be stored on any suitable computer-readable media such as RAMs, ROMs, flash memory, EEPROMs, optical devices (CD or DVD), hard drives, floppy drives, or any suitable device. In some variations, the computer-executable component is a general or application specific processor, but any suitable dedicated hardware or hardware/firmware combination device can alternatively or additionally execute the instructions.

Although omitted for conciseness, the preferred embodiments include every combination and permutation of the various system components and the various method processes.

As a person skilled in the art will recognize from the previous detailed description and from the figures and claims, modifications and changes can be made to the preferred embodiments of the invention without departing from the scope of this invention defined in the following claims.

What is claimed is:

1. A method comprising: with a machine learning platform:
accessing user data;
accessing purpose information identifying a purpose for a model;
identifying canonical features by using the purpose information;
detecting one or more of the canonical features from the accessed user data;
selecting a model type in accordance with the purpose information;
selecting a target in accordance with the purpose information;
select model parameters in accordance with the purpose information;
generating a model having the selected model type by using the accessed user data, wherein the model uses the detected canonical features as inputs, predicts values for the selected target, and includes the selected model parameters;
generating business analysis information for the generated model, in accordance with the purpose information; and
providing the business analysis information to at least one system external to the machine learning platform.

2. The method of claim 1, wherein the machine learning platform automatically identifies canonical features, detects canonical features form the accessed user data, selects the model type, selects the target, selects the model parameters, generates the model, generates the business analysis information, and provides the business analysis information in response to accessing the user data and the purpose information from a user system via a user interface system included in the machine learning platform.

3. The method of claim 1, wherein the identified purpose is one of: automotive loan origination, consumer loan origination, business loan origination, loan repayment prediction, new loan solicitation, curable loan identification, applicant identification, and business loan repayment.

4. The method of claim 1,
wherein accessing purpose information identifying a purpose for a model comprises: accessing model purpose data that is stored in association with the identified model purpose,
wherein the accessed model purpose data defines the canonical features to be used as model inputs, the model type, the target, and the model parameters, and
wherein identifying canonical features comprises: identifying canonical features defined by the accessed model purpose data.

5. The method of claim 4, wherein detecting one or more of the canonical features from the accessed user data comprises: extracting canonical features from the accessed user data by applying at least one predetermined transformation rule.

6. The method of claim 5, wherein the accessed model purpose data defines the at least one predetermined transformation rule used to extract the canonical features from the accessed user data.

7. The method of claim 4,
wherein the accessed model purpose data defines a business analysis process, and
wherein generating business analysis information for the generated model comprises: performing the business analysis process defined by the accessed model purpose data.

8. The method of claim 4,
further comprising: with the machine learning platform: evaluating the generated model,
wherein the accessed model purpose data defines at least one business metric, and
wherein evaluating the generated model comprises:
computing a business metric value for each business metric defined by the model purpose data for the generated model,
computing a business metric value for each business metric defined by the model purpose data for an original model,
comparing the business metric values for the original model with the corresponding business metric values for the generated model, and
generating evaluation information that includes results of the comparison between the business metric values for the original model and the business metric values for the generated model.

9. The method of claim 8, wherein evaluating the generated model further comprises: performing fair lending disparate impact analysis, and generating evaluation information includes results of the fair lending disparate impact analysis.

10. The method of claim 9, wherein evaluating the generated model further comprises: performing model accuracy analysis, and generating evaluation information includes results of the model accuracy analysis.

11. The method of claim 10,
further comprising: with the machine learning platform: generating explanation information for model output generated by the model.

12. The method of claim 11, wherein the model is a credit model that generates a credit score for a credit application, and wherein the explanation information generated for the model output includes FCRA Adverse Action Reason Codes.

13. The method of claim 11,
further comprising: with the machine learning platform:
monitoring the model to detect at least one of feature drift, unexpected inputs, unexpected outputs, population instability, and unexpected economic performance; and
providing an alert to at least one system in response to detecting at least one of feature drift, unexpected inputs, unexpected outputs, population instability, and unexpected economic performance.

14. The method of claim 1,
further comprising: with the machine learning platform:
automatically generating documentation for the model, wherein the documentation includes:
documentation information identifying the accessed user data,
documentation information identifying the identified canonical features,
documentation information identifying the detected canonical features,
documentation information identifying the selected model type,
documentation information identifying the selected target,
documentation information identifying the selected model parameters,
information describing generating of the model, and
the business analysis information; and
providing the generated documentation to a system external to the machine learning platform.

15. The method of claim 4, wherein the user data and the purpose information are received one or more of an external loan origination system and an external loan management system.

16. The method of claim 15, wherein the model purpose data is received from an external computing system of a domain expert.

17. The method of claim 1, wherein the generated model includes at least a gradient boosted tree forest (GBM) coupled to base signals, and a smoothed approximate empirical cumulative distribution function (ECDF) coupled to output of the GMB, wherein output values of the GBM are transformed by using the ECDF and presented as a credit score.

18. The method of claim 1, wherein the generated model includes submodels including at least a GMB, a neural network, and an Extremely Random Forest (ETF), wherein outputs of the submodels are ensembled together using one of a stacking function and a combining function, and wherein an ensembled output is presented as a credit score.

19. The method of claim 1, wherein the generated model includes submodels including at least a neutral network (NN), a GBM, and an ETF, wherein outputs of the submodels are ensembled by a linear ensembling module, wherein an output of the linear ensembling module is processed by a differentiable function, and wherein an output of the differentiable function is presented as a credit score.

20. The method of claim 1, wherein the generated model includes at least a neutral network (NN), a GBM, and a neural network ensembling module, wherein an output of the neural network ensembling module is processed by a differentiable function.
